(19) United States
(12) Patent Application Publication
(10) Pub. No.: US 2016/0328887 A1
(43) Pub. Date: Nov. 10, 2016

(54) SYSTEMS AND METHODS FOR PROVIDING ASSISTANCE FOR MANIPULATING OBJECTS USING VIRTUAL PROXIES AND VIRTUAL REPLICAS

(71) Applicant: THE TRUSTEES OF COLUMBIA UNIVERSITY IN THE CITY OF NEW YORK, New York, NY (US)

(72) Inventors: Carmine Elvezio, Bellmore, NY (US); Mengu Sukan, Stamford, CT (US); Ohan Oda, Sunnyvale, CA (US); Steven Feiner, New York, NY (US); Barbara Tversky, New York, NY (US)

(73) Assignee: THE TRUSTEES OF COLUMBIA UNIVERSITY IN THE CITY OF NEW YORK, New York, NY (US)

(21) Appl. No.: 15/146,764

(22) Filed: May 4, 2016

Related U.S. Application Data
(60) Provisional application No. 62/156,619, filed on May 4, 2015.
(60) Provisional application No. 62/327,270, filed on Apr. 25, 2016.

(51) Int. Cl. G06T 19/20; G06T 7/00; G09B 19/00; G02B 27/01; G09B 5/02; G06T 19/00; G06F 3/01

(52) U.S. Cl. CPC G06T 19/20; G06T 19/006; G06T 7/004; G06F 3/011; G02B 27/0172; G09B 5/02; G09B 19/003; G06T 2219/024; G06T 2219/2004; G06T 2219/2008; G06T 2207/20081; G02B 2027/014

(57) ABSTRACT

Systems and methods for providing assistance for manipulating objects using virtual proxies and virtual replicas are provided. Disclosed systems enable a remote or co-located subject matter expert (SME) to provide guidance to a local user on how to manipulate physical or virtual objects in the local user's environment. The local user views an augmented reality (AR) display of the local environment. The SME views a virtual reality (VR) or AR display of the local environment. The SME manipulates virtual proxies and virtual replicas to demonstrate to the local user how physical or virtual objects in the local environment should be manipulated. In other scenarios, a local user is provided instruction by using a display from which the local user can view the local environment. Manipulations of objects are tracked and the system provides the user feedback on whether the objects are properly oriented.

### CROSS REFERENCE TO RELATED APPLICATION

This application is related to, and claims priority from, Provisional Patent Application No. 62/156,619, entitled “Systems and Methods for Using Virtual Replicas for Remote Assistance in Virtual and Augmented Reality,” which was filed on May 4, 2015, and Provisional Patent Application No. 62/327,270, entitled “Systems and Methods for Using Virtual Replicas for Remote Assistance in Virtual and Augmented Reality,” which was filed Apr. 25, 2016, the entire contents of both of which are incorporated by reference herein.

### BACKGROUND

Task guidance has been an active topic in the fields of virtual reality (VR) and augmented reality (AR), with applications to a wide range of domains, including the operation, assembly, maintenance, and repair of equipment. Seeing instructional graphics overlaid directly on the actual task environment can improve a user's understanding compared to viewing instructions displayed on a nearby monitor or in a paper manual. One approach to task guidance involves a remote (or co-located) individual (such as a subject matter expert or “SME”) assisting a local user. Certain approaches to remote guidance using voice or video limit how the SME can instruct the local user, especially for operations that require 3D spatial referencing and action demonstration. Language describing spatial locations and actions in space can be ambiguous or vague, leading to confusion and error. By contrast, AR can enable a SME to directly interact with the local environment for 3D spatial referencing and action demonstration, and allow a local user to visualize instructions directly overlaid on the environment.

Certain current approaches to VR- and AR-based remote task guidance enable SMEs to present instructional elements (such as 3D arrows) to perform hand gestures, and to place annotations (such as 3D tags or sketches) on physical objects. However, in using these approaches, it can be challenging or even impossible for a SME to refer to a part of physical object in the local user's environment that is occluded or to demonstrate actions on it. Further, although certain techniques allow a SME to augment a local user's environment with additional visualizations (such as 3D arrows and annotations), they do not necessarily support a SME's direct manipulation of replicas of tracked physical objects to demonstrate actions in the local user's environment.

Certain VR-based systems are also useful for guiding a user without the assistance of a SME. For example, such systems are useful for guiding a user in performing a task that requires the user to rotate an object to match a specific orientation in an external coordinate system. This includes tasks in which one object must be oriented relative to a second prior to assembly, as well as tasks in which objects must be held in specific ways to inspect them. Certain techniques make use of guidance mechanisms for some 6-degree of freedom (DOF) tasks using wide field of view (FOV), stereoscopic VR and AR head-worn displays (HWDs). However, there is an increasing need for using smaller (FOV), lightweight monoscopic HWDs, such as Google Glass®, for such tasks. Indeed, such lightweight HWDs can be more comfortable and less intrusive than stereoscopic HWDs.

### SUMMARY

In a first aspect of the present disclosure, methods for providing task guidance are provided. An example method includes tracking and viewing one or more objects, which can be either physical or virtual objects, on a first display. The display can be, for example, a head-worn display (HWD), a handheld display, a stationary display, such as a computer monitor, or any computer-based display. Further, the display can be an optical see-through display. Alternatively, the objects can be viewed through or reconstructed from data obtained from sensors or a video see-through display. Objects can also be viewed directly, and serve as targets on a projector-based display, such as used in a spatial augmented reality system.

The method further includes displaying first and second objects on a second display, wherein each object corresponds to one of the tracked objects. The method further includes selecting and annotating the object, and selecting and annotating the second object. Responsive to annotating the first and second objects, the method renders corresponding annotations to the first and second tracked objects viewed on the first display.

In another aspect of the present disclosure, a second method for providing task guidance is provided. The method includes tracking and viewing first and second objects, which can be physical or virtual objects, on a first display. The display can be an HWD, handheld display, stationary display, or any computer-based display. Further, the display can be an optical see-through display. Alternatively, the objects can be viewed through or reconstructed from data obtained from sensors or a video see-through display. Objects can also be viewed directly, and serve as targets on a projector-based display, such as used in a spatial augmented reality system. The method further includes displaying first and second objects on a second display, which can be an HWD, handheld display, or any computer-based display, wherein each object corresponds to one of the tracked objects. The method further includes selecting the first object and creating a virtual replica thereof on the second display. Responsive to creating the virtual replica, the method displays on the first display a corresponding virtual replica of the first tracked object.

The method can further include selecting and moving the virtual replica to a position relative to the second object on the second display. Responsive to moving the virtual replica on the second display, the method moves the virtual replica on the first display to a position relative to the second tracked object, where said position relative to the second tracked object corresponds to the position of the virtual replica on the second display relative to the second object.

In another aspect of the present disclosure, a third method for providing task guidance is provided. The method includes tracking and viewing a physical object, a virtual object, or a virtual proxy of a tracked physical object on a display. The display can be an HWD, a handheld or stationary display, or any computer-based display. The method further includes determining a target orientation for the object. Further, the method can include rendering a pair of virtual handles (poles) on the display such that each virtual handle originates at the point about which the object will rotate and extends outward. A pair of target shapes can be rendered on the display, each target shape corresponding to one of the virtual handles, where both virtual handles overlap with their corresponding target shapes when the object is at the target orientation.

### BRIEF DESCRIPTION OF THE DRAWINGS

FIGS. 1a and 1b depict, respectively, a VR view and an AR view of a local user's environment, as presented to a subject matter expert, in accordance with one or more embodiments.

FIG. 2 depicts an example of a VR environment displayed to a SME, according to one or more embodiments.

FIG. 3 illustrates the interpenetration of a first virtual replica and a second virtual replica.

FIGS. 4a to 4c depict different constraints in degrees of freedom as applied to a virtual replica, in accordance with embodiments.

FIG. 5 depicts an example of a tablet display on which a subject matter expert annotates virtual proxies and virtual replicas, according to embodiments.

FIGS. 6a to 6c depict a rotation of a virtual proxy by a local user as instructed in accordance with one or more embodiments.

FIGS. 7a to 7c depicts a rotation of a virtual proxy in accordance with one or more embodiments.

FIGS. 8a to 8c depicts a rotation of a virtual proxy in accordance with one or more embodiments.

FIGS. 9a to 9c depicts a rotation of a virtual proxy in accordance with one or more embodiments.

### DETAILED DESCRIPTION

Systems and methods for using VR and AR for task guidance are disclosed herein. According to some embodiments, techniques described herein use virtual proxies and virtual replicas for remote assistance in VR and AR environments. In these embodiments, VR or AR are used by a remote SME, while AR is used by a local user situated in an environment that includes one or more physical objects that the local user is tasked with manipulating. The SME and local user each wears a stereoscopic HWD.

According to aspects of the present disclosure, the SME utilizes a pointing device to create virtual replicas of virtual proxies of the physical objects in the local user's environment. In some embodiments, the SME can utilize other means for selecting objects, such as a voice command or the SME's tracked hand. The virtual proxies and virtual replicas are displayed to the SME in a VR environment. Alternatively, the SME can view the virtual proxies and virtual replicas in an AR environment. The SME then uses the pointing device to point in 3D to portions of the virtual replicas to annotate them. Using AR, the annotations are viewable by the local user in the local user's environment. The annotations are designed to guide the local user on how the physical objects should be manipulated in order to perform a particular task.

According to other aspects of the present disclosure, the SME creates virtual replicas of virtual proxies of the physical objects in the local user's environment and demonstrates actions in 3D by manipulating, rather than merely annotating, the virtual replicas. The SME manipulates the virtual replicas subject to constraints so as to prevent the SME from manipulating the virtual replica in such a way that the local user would not be able to manipulate the corresponding physical object. For example, such constraints can be designed to prevent the SME from placing the virtual replica relative to a physical object such that the body of the virtual replica intersects the body of the physical object and annotations. Techniques disclosed herein can enable the SME to create and manipulate virtual replicas of physical objects in the local environment, to refer to parts of those physical objects, and to indicate actions to be performed on them. Such techniques can be useful, for example, for providing guidance on how to manipulate parts of physical objects that are occluded or difficult to access.

In still other aspects of the present disclosure, visualization paradigms for 3-DOF guidance using smaller, monoscopic HWDs are described. According to embodiments, techniques for interaction with and visualization of virtual proxies of a physical object located in a local user's environment are disclosed. According to the disclosed techniques, a local user is provided with guidance in performing unconstrained 3D rotations of a handheld physical object with or without assistance from a remote SME. That is, the local user views a VR simulation (i.e., a virtual proxy) of the physical object and is guided as to how the object should be rotated or otherwise manipulated such that the physical object is oriented at a predetermined target position. These techniques are described in the context of a local user that is wearing a lightweight HWD, such as Google Glass®. However, the described techniques are also applicable to other display configurations, including but not limited to stereoscopic optical-see-through or video-see-through head-worn displays, hand-held displays, or projector-based displays.

According to some embodiments, techniques for VR- and AR-based task guidance, which enable a remote or co-located SME to guide a local user on how to manipulate physical objects in the local user's environment, are based on the ways a SME usually guides a novice when they are co-located. In these scenarios, a SME can point to relevant places on a physical object and/or demonstrate appropriate actions that the novice should take with respect to the physical object. The techniques disclosed herein can also enable the SME to create, annotate, and manipulate virtual replicas of physical counterparts (i.e., objects) in the local user's environment. The SME can perform operations using the virtual replicas, the results of which are communicated to the local user.

Physical objects with which the local user interacts can be modeled and tracked in 6-DOF. In some embodiments, 3D models of the objects are statically constructed and, using suitable technology (e.g., depth cameras and RGB cameras), the objects' movements are tracked in the local environment of the local user. In other embodiments, the local environment can be dynamically constructed and tracked in real time (e.g., using depth cameras and RGB cameras) while the physical objects are being manipulated.

It is assumed that the SME's virtual environment contains a virtual proxy for each relevant physical object in the local user's environment, and that the position and orientation of each virtual proxy is determined by the position and orientation of the corresponding physical object in the local user's environment. That is, a virtual proxy is rendered in a display that is being viewed by the SME. Using the techniques described herein, the SME can create a virtual replica of the physical object by “grabbing” its virtual proxy.

For example, using a pointing device the SME can point to and select the virtual proxy, thereby creating a replica of the virtual proxy that is also viewable by the SME in the SME's virtual environment. According to one or more embodiments, the SME can create the virtual replica of a virtual proxy by intersecting a 6-DOF tracked manipulation device with the proxy and pressing a button on the manipulation device. The manipulation device can be rendered with a simple cubic box in the VR display. As long as the button is depressed, the virtual replica remains rigidly attached to the manipulation device and can be manipulated freely. When the button is released, the virtual replica stays at the position and orientation at the time of release. The SME can grab and manipulate the virtual replica as many times as is required. In one embodiment, if the SME grabs the virtual proxy, the previously created virtual replica of that proxy will disappear and a new virtual replica is created. The virtual replica can then be manipulated in 6-DOF. After release, the virtual replica can then be grabbed again to manipulate it further. Meanwhile, on an AR display viewed by the local user, the virtual replicas (as manipulated by the SME) are also displayed in context of their physical counterparts. Further, the 6-DOF position and orientation of the physical objects in the local user's environment are tracked and streamed to the SME's system to update the virtual proxies.

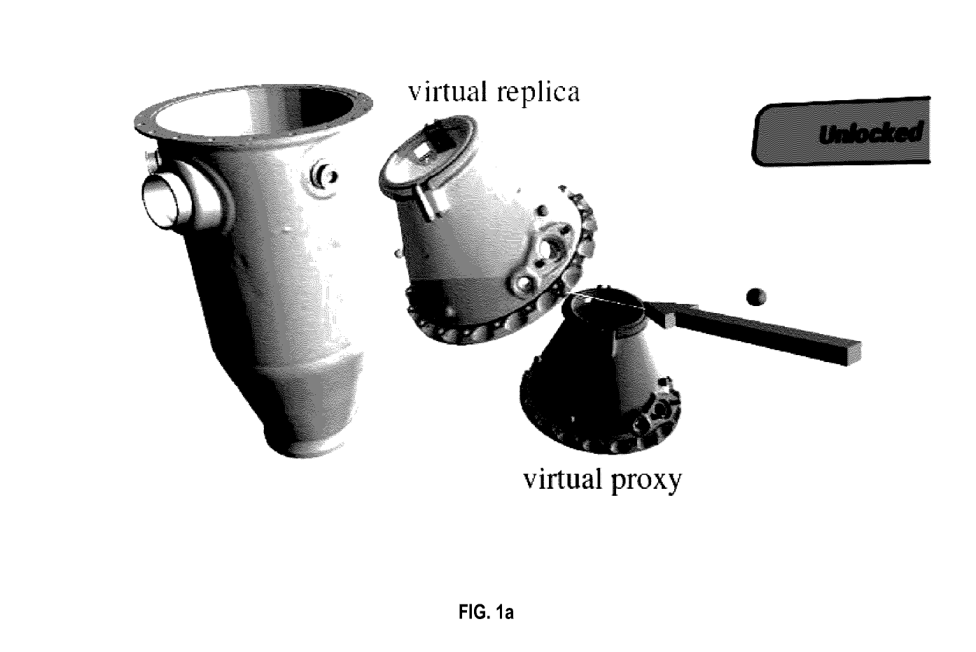

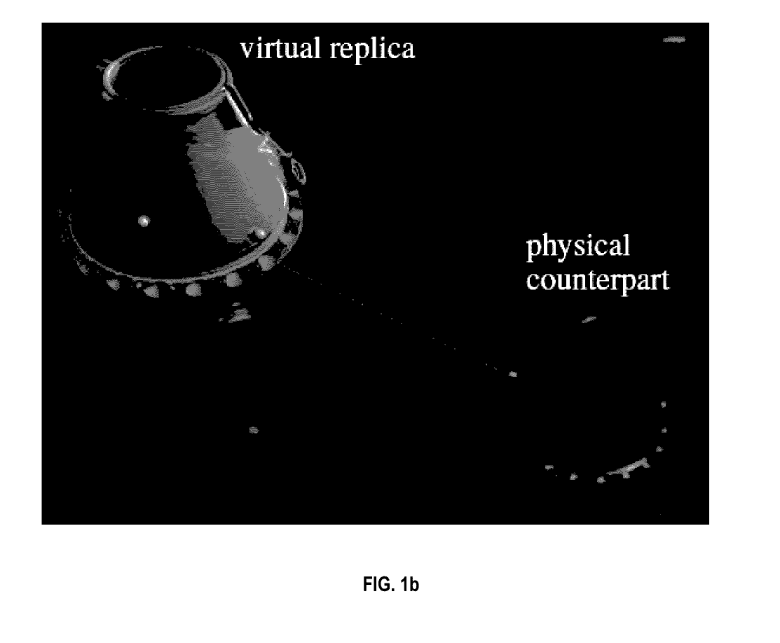

In one embodiment, the SME's display can transition seamlessly between two views without affecting what is displayed to the local user. The two views are a VR view and an AR view of the local user's environment. In either view, the SME can “grab” virtual proxies to create virtual replicas, but the virtual proxies cannot be moved by the SME. In each case, the manipulation of the virtual replicas is displayed to the local user via the local user's display. An example of a VR view of the SME is depicted in FIG. 1a. In the VR view, the SME is presented with a virtual environment, viewed from its own perspective, that includes virtual proxies of important tracked objects from the local user's environment, whose position and orientation are updated in real time as the local user manipulates them. Changes to the local user's environment are communicated to the SME's VR view by communicating geometric transformations of objects in the local user's environment. Since geometric transformations, rather than video, are communicated, network latency is reduced and the SME is not restricted only to views seen by the local user.

On the other hand, in the AR view, the SME interacts with camera imagery captured from the perspective of the local user. An example of the AR view of the SME is depicted in FIG. 1b. Having the SME interact with imagery captured from the local user's environment can be useful when the SME wants to see the task environment from the local user's point of view, and when the task environment contains unmodeled objects or objects that do not correspond to their models (e.g., if the objects have been damaged). The SME can also freeze their view to support interaction with the physical objects at their positions and orientations when the view was frozen. This can be useful when the local user is moving their own display or a physical object in their environment.

One technique by which a physically co-located SME can guide a user through an assembly task is by pointing to locations on the physical objects in the common environment and instructing the user on how to align them. For example, when assembling furniture, a SME can point to a peg on a first piece and a hole on a second piece and instruct the user that the peg needs to be inserted into the hole. Similarly, in the VR- and AR-based system disclosed herein, a remote SME wears a stereoscopic HWD that displays a VR environment containing virtual proxies that correspond to physical objects in the local user's environment. The local user, on the other hand, wears a stereoscopic HWD that displays an AR environment, where the physical objects of the local user's environment are annotated in accordance with annotations created by the SME in the VR environment.

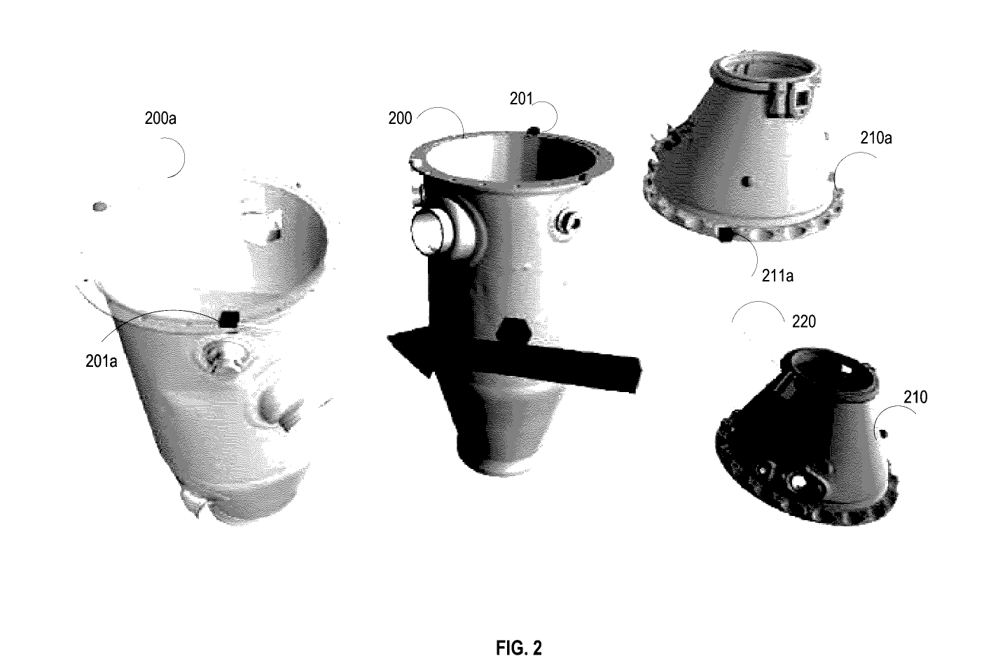

FIG. 2 depicts an example of a VR environment displayed to a SME, according to one or more embodiments. The physical objects of interest in this example are the top and bottom of an aircraft engine combustion chamber, which are joined at specific contact points. As shown in the figure, a SME specifies three pairs of contact points that enables the SME to convey the 6-DOF pose of the top of the chamber (object A) relative to the bottom of the chamber (object B). However, it should be noted that any number of pairs of contact points can be specified. According to this embodiment, the remote SME manipulates a tracked pointing device that controls a ray whose intersection with an object defines a contact point on that object. The SME can create one or more virtual replicas of the displayed virtual proxies. However, it can be the case that the location on the virtual proxy at which the contact point is to be defined is visible to the SME (i.e., the location is not occluded by the body of the object or by any other object visible in the VR environment). In this latter case, the SME can define contact points on the virtual replica itself.

Once the SME has created zero or more virtual replicas, the SME can then point to a location on either a virtual replica or its virtual proxy to place annotations anywhere on the corresponding physical object. If the location on the virtual proxy is occluded, or simply for convenience, the SME can freely manipulate a virtual replica of the virtual proxy to find a suitable pose from which to place an annotation. When an annotation is placed on a virtual replica, the annotation appears on both the virtual replica and on the corresponding virtual proxy in the SME's VR environment. The annotation also appears on the physical object in the local user's environment. Annotations are attached to the objects on which they are placed. Thus, the annotations are updated dynamically as the objects are manipulated. Once annotations for corresponding points have been placed on objects (either a virtual proxy or a virtual replica) by the SME, a “rubber-band” line appears between the corresponding annotations on both objects. This can assist the local user identify which annotated points should be aligned.

For example, referring to FIG. 2, an SME selects virtual proxy 200, which corresponds to the bottom of the aircraft engine combustion chamber, and creates virtual replica 200a. Furthermore, the SME selects virtual proxy 210, which corresponds to the top of the aircraft combustion chamber, and creates virtual replica 210a. In order to connect the top and bottom of the aircraft engine combustion chamber, three pairs of contact points are identified. With respect to the top of the aircraft engine combustion chamber, the contact points are visible on the virtual proxy, but they are disposed in such a way that it is difficult for the SME to precisely identify all contact points. Therefore, as shown in the figure, the SME uses the pointing device to rotate virtual replica 200a in a counterclockwise direction and pitch virtual replica 200a slightly forward in order better expose a specific contact point.

Likewise, one of the contact points on virtual proxy 210 is obstructed by the body of the object. Thus the SME rotates virtual replica 210a so that all contact points are visible. Once virtual replicas 200a and 210a are positioned according to the preference of the SME, the SME proceeds to create the required pairs of contact points by annotating locations on virtual replicas 200a and 210a. For example, using the pointing device, the SME creates a contact point 201a on virtual replica 200a. Next, the SME creates a corresponding contact point 211a on virtual replica 210a. According to embodiments, this is accomplished by the SME selecting the contact point on virtual replica 200a with, for example, the right mouse button depressed and then selecting the contact point on virtual replica 210a also with the right mouse button depressed. In other embodiments, the SME selects the two contact points in succession by double-clicking. Other ways of selecting the virtual replicas so as to create corresponding contact points are contemplated and are in the scope of the present disclosure.

As shown in FIG. 2, once a pair of contact points is defined, a line connecting the contact points is displayed between the corresponding points of the virtual proxies. The contact point on virtual proxy 200 corresponding to contact point 201a is signified in the figure as point 201 on virtual proxy 200. However, the point on virtual proxy 210 corresponding to contact point 211a on virtual replica 210a is occluded. Thus, the line 220 that connects the two contact points on virtual proxies 200 and 210 is partially obstructed by (i.e., extends behind) virtual proxy 210. Once the contact points 201a and 211a are defined on virtual proxies 200a and 210a, the SME proceeds in a similar fashion to define the other two pairs of contact points. It should be noted that, as the SME completes the placement of any annotation (e.g., a contact point on a virtual replica), the local user's AR-based view of the physical objects in the local environment displays that annotation on the physical objects that correspond to the virtual proxies in the SME's VR-based display. However, in other embodiments, the local user's AR-based view displays the annotations made by the SME after the SME has finished creating a set of annotations corresponding to a particular task, such as, for example, placing one object relative to another. Thus, in this way, the local user is provided guidance on how one physical object (e.g., the top portion of an aircraft engine combustion chamber) is to be fitted to another physical object (e.g., the bottom portion of an aircraft combustion chamber.

Further, in one or more embodiments, the contact points on virtual replicas 200a and 210a are displayed as metaobjects, each having a different shape and color, and which protrude from the surface of the virtual replica (or virtual proxy, as the case may be). In some embodiments, each pair of corresponding contact points on different virtual replicas are marked by metaobjects of the same shape and color. According to other embodiments, this correspondence can be made evident without relying on the use of identical shapes and/or colors for the metaobjects. When instructing the local user, the SME can select a metaobject from a palette, for example. The SME can then point to either a virtual replica or a virtual proxy to place the metaobject at a contact point. In some embodiments, the SME places metaobjects at three contact points of each virtual replica or proxy to fully define the 6-DOF pose of the first virtual object relative to the second. In some embodiments, the SME selects a metaobject and points to a virtual object (i.e., a virtual replica or proxy) using a 6-DOF tracked pointing device, with two buttons to trigger pointing and choosing of a metaobject. In some cases, the SME holds the manipulation device with the non-dominant hand, and the pointing device with the dominant hand. Further, in some embodiments, when the SME points to an object, a 3D arrow appears on the local user's AR display of its local environment to help the local user identify the pointing pose. The arrow, which is similar in appearance to that shown in the SME's view in FIG. 2, appears relative to the physical object, since the local user cannot see the corresponding virtual proxy.

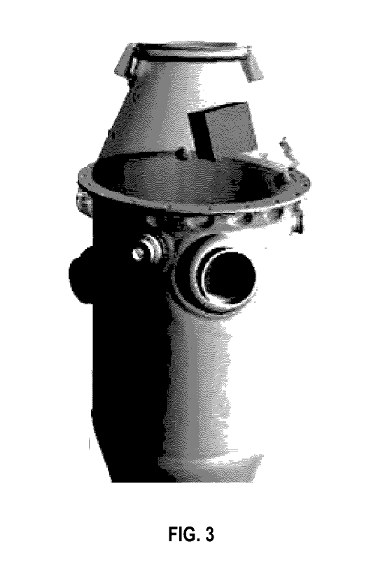

In another embodiment, the SME uses a virtual replica to directly demonstrate how to move a physical object relative to the other physical objects in the local user's environment to a final pose in that environment. Referring again to the furniture assembly analogy, this approach involves a physically co-located SME actually picking up a furniture piece, physically aligning it relative to another piece to show the local user how the two parts fit, and then placing it back so that the local user can imitate the demonstrated action. When implementing this paradigm in a VR- and AR-based system, one issue that can arise is that the virtual replica of one virtual proxy can interpenetrate another virtual replica (or virtual proxy). This scenario is illustrated in FIG. 3.

As shown in the figure, when the SME places the top of the aircraft engine combustion chamber (i.e., virtual replica 210a) atop the bottom piece (i.e., virtual proxy 200), the two virtual objects can interpenetrate each other because there is no force feedback when the two virtual objects “touch” each other in the SME's virtual environment. Interpenetration between virtual objects is more likely at the fine-tuning stage, where the SME is finalizing the position of one virtual object relative to another. This can cause confusion for the local user, as it would be difficult to interpret exactly how the physical objects should be moved with respect to the local user's environment.

To address this problem, certain embodiments employ a constraint-based approach. In such an approach, constraints can be specified by the SME prior to providing guidance to the local user, inferred from CAD models, or derived from a physics-based simulation. This technique assumes that, in many assembly tasks, two rigid bodies fit together in a constrained way in which there is some leeway in translation or orientation. Thus, according to one embodiment, the SME can orchestrate a set of rigid-body constraints, prior to guiding the local user, by placing the virtual replica at a location (or, for a translational constraint, a region) and specifying the DOFs that the virtual replica can have. In this way, the SME can fine-tune the position and/or orientation within the DOFs allowed while providing guidance to the local user. The constraint-based approach prevents unwanted interpenetration between virtual replicas and proxies. It also reduces potential manipulation errors introduced while fine-tuning the final 6-DOF pose near a constrained region.

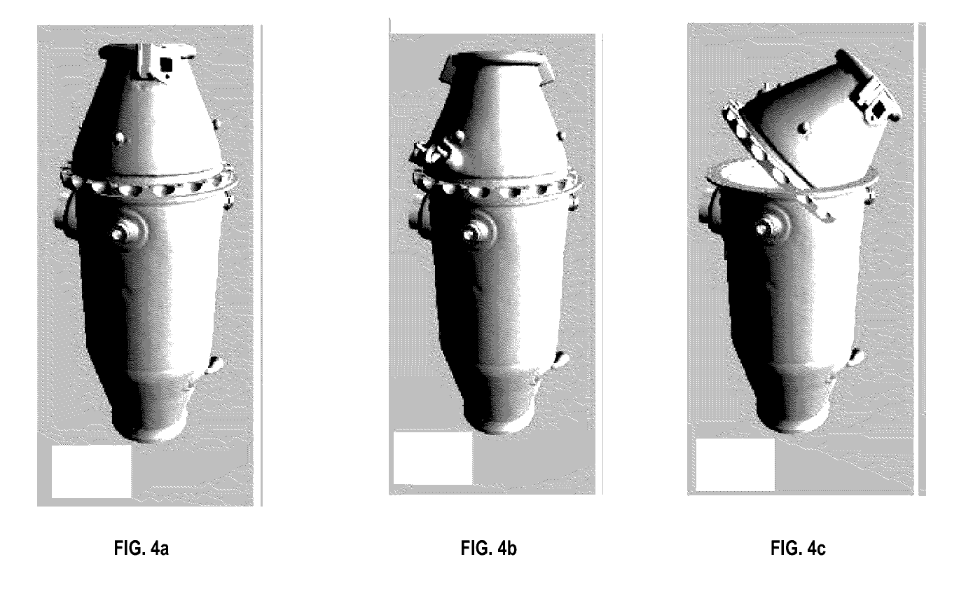

For example, in FIGS. 4a and 4b, the SME has specified that, from the position where virtual replica 210a is moved sufficiently close to virtual proxy 200, virtual replica 210a is snapped into position and restricted to movement only in 1-DOF. Specifically, virtual replica 210a can then be rotated only about its vertical axis. Thus, the SME can only demonstrate, from this position, that virtual replica 210a can be fit to virtual proxy 200 by “twisting” virtual replica 210a about its vertical axis. In this case, the configuration shown in FIG. 4c would be prevented.

According to aspects of the present disclosure, the SME controls the manipulation device with the dominant hand to create a virtual replica from its virtual proxy and to place the replica directly at the desired location. The virtual replica “snaps” to the constrained location with a smooth transition when the SME releases the virtual replica near a region where a constraint has been specified. The virtual replica then remains at the location at which it is released if there are no constraints within a threshold distance and orientation.

The SME's manipulations of virtual replicas in its VR environment are displayed on the local user's AR display of its physical environment. Once the SME has specified the final 6-DOF position of the virtual replica, the local user, after viewing the demonstration performed by the SME, determines how to place the physical counterpart to match that pose. However, this can raise another issue. Specifically, the local user can have difficulty understanding how to match the position of the physical object to that of the virtual replica because of difficulties in performing the necessary mental rotation between the virtual representation of the objects and the actual physical objects in the local user's environment.

To address this problem, embodiments of the present disclosure make use of a set of landmark “metaobjects” on the virtual replica, which are duplicated on the virtual replica's physical counterpart. A connecting line between each metaobject and its duplicate further simplifies the matching process. The local user can use these metaobjects as cues to match the 6-DOF pose of the physical counterpart with the virtual replica placed by the SME. Furthermore, according to embodiments, a virtual replica is faded from the display of the local user as the local user maneuvers the physical counterpart to within a predetermined threshold distance to the virtual replica placed by the SME, while maintaining the visibility of the metaobjects. The appearance of the metaobjects can be sufficient for the local user to match the pose between the physical counterpart and its virtual replica when they are sufficiently close to each other.

Metaobjects can be defined by the SME or automatically generated (e.g., from shape analysis) prior to providing guidance to the local user. Metaobjects can be added anywhere on the virtual replica that represents a physical object, preferably on prominent geometrical points, and will appear in the local user's environment as soon as the SME creates a virtual replica from a virtual proxy. In one embodiment, the virtual replica fades when bounding boxes of the virtual replica and physical counterpart start to overlap, and fades in when they no longer overlap. To avoid fading of the replica while the SME manipulates it, the virtual replica fades after the SME completes placement of the virtual replica.

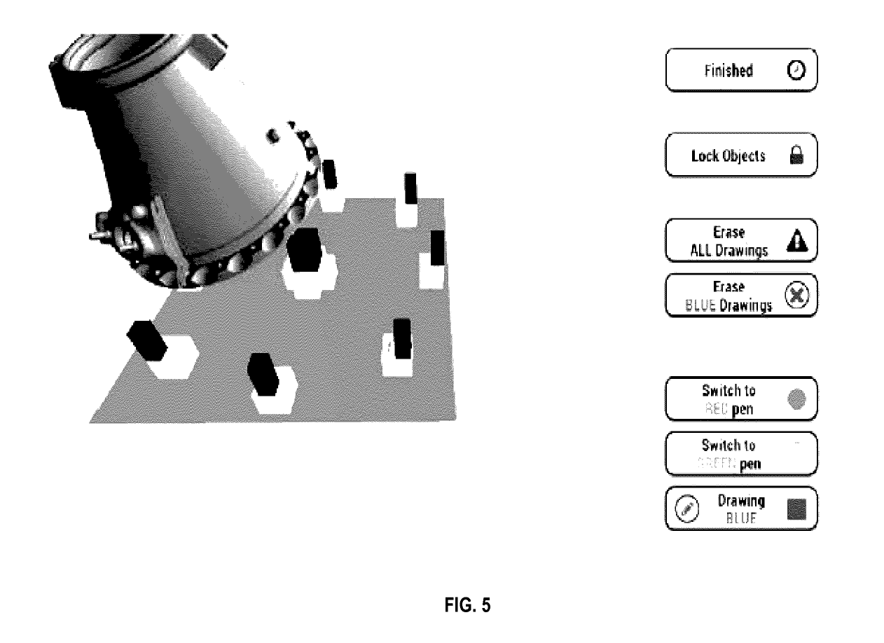

In another embodiment, a remote task guidance system provides the SME with a 2D annotation system based on a multi-touch tablet or personal computer (PC). In some cases a projector is provided in the local user's environment to project the SME's instructions in that environment. FIG. 5 depicts an example of a tablet display, according to embodiments. As shown, 2D annotations are sketched by the SME on a multi-touch tablet. Controls are rendered on the right side of the screen, which can be used, for example, to annotate in different colors. Annotations sketched by the SME are displayed in the local user's environment through the HWD worn by the local user. In tablet-based embodiments, the SME uses multi-finger gestures to draw annotations on and navigate among virtual proxies. Each point sketched on the tablet screen is projected from the center of projection onto the closest point on the surface of the proxy object visible at that pixel, such that the sketches appear in 3D on the surfaces of the proxies.

According to embodiments, the SME can perform the following actions using the tablet: line sketching, dollying in or out, intrinsic camera rotation, orbiting the camera about a point, panning, dollying towards a tapped location, and resetting the camera to a default location. The SME can also sketch using different colors and erase the sketches. Lines are also capable of being drawn with a glow effect. In the AR view, the SME can sketch, but not navigate, since the SME cannot control the local user's perspective.

As previously mentioned, certain aspects of the present disclosure are directed to, but are not limited to, visualization paradigms for 3-DOF guidance using smaller, monoscopic HWDs. In these embodiments, a virtual representation of a physical object is tracked and rendered as a virtual proxy that is viewable through the monoscopic HWD. Elements of the visualization techniques disclosed herein relate to providing task assistance using AR. In the real world, instruction manuals have long used arrows to depict rigid body transformations. This approach has been adopted in certain computer-based documentation systems, including ones utilizing AR. For example, arrows can be rendered to cyclically move in a direction in which an object is to be translated or interactively change in size and color to indicate direction and magnitude of a 1-DOF rotation needed to align two tracked workpieces. Ghosting is another visualization technique used in real time AR task guidance systems to visualize workpiece placement. Ghosting and animation have also been used to provide visual hints on how to move handheld props to activate gestures in an AR system.

Techniques disclosed herein focus on the manual orientation of handheld objects. These techniques improve upon existing AR-based methods by providing users with continuous feedback designed to reduce cognitive load, facilitate corrective action, and provide confirmation once the target orientation is reached.

Visualization techniques disclosed herein utilize curved 3D arrows to communicate 3D rotations. In some embodiments, cylindrical arrows having a cone for the arrow head and a curved cylinder for the body are used. In other embodiments, to improve perceptibility, flat, curved 3D arrows having an extruded triangle for the arrow head and an extruded rectangle for the body are used. Further, different colors have been applied to the inside-facing walls of the arrow than to the outside-facing walls.

In addition, in order to increase the amount of information encoded in the arrow body (such as, e.g., the direction of rotation of the arrow), each single curved arrow can be broken into smaller segments along the same curve, analogous to a dashed line.

In several embodiments, the length of the arrow body is changed to represent the magnitude of the remaining rotation required to be performed on the physical object. According to some embodiments, a ring (or extruded annulus) that contains repeating arrows, and which does not disappear based on the magnitude of the remaining rotation, is utilized. The ring can be semi-transparent and is the same color as the corresponding arrow. In order to give the appearance that the arrow body is reduced in size in response to a reduction in the remaining required rotation of the physical object, a custom pixel shader is employed. The custom pixel shader can take as a parameter the remaining angle of rotation and paint only those pixels that were within that angle of the arrow tip. Thus, only the portion of the arrow corresponding to the remaining angle of rotation is rendered.

According to embodiments, a visualization technique for displaying a virtual proxy utilizing annotated “handles” is provided. This technique uses two poles that extend from the center of the virtual proxy. The poles can be rendered to look like physical handles that are rigidly attached to the virtual proxy. Thus, in some embodiments, a spherical knob is added to the end of each pole to bolster the visual metaphor that the poles are handles that can be grabbed and moved. However, it should be noted that the handles are visual representations that, in some embodiments, are not actually grabbed or manipulated directly by an end user. In other embodiments, the virtual handles are capable of being directly manipulated by the end user. Further, the poles help provide depth cues via occlusion and perspective, which can be beneficial when the handles are near their targets, i.e. during the fine-tuning stage. Each target can be implemented as a torus having a hole wide enough to have its corresponding handle fit without touching the torus once the handle is inside the hole.

Using this technique, a local user rotates the physical shape so that each handle attached to the virtual proxy passes through its corresponding torus. When a handle is contained within the hole of its corresponding torus, the torus signals that a proper alignment has been completed with respect to that handle. For example, the torus can be programmed to turn green or another color to indicate proper alignment for the handle/torus pair. If the user chooses to align the handle/torus pairs sequentially, then once one of the handle/torus pairs is aligned, the local user maneuvers the second handle into its corresponding torus while keeping the first handle in place. This can be achieved by executing a 1-DOF rotation of the physical object. Alternatively, the user could bring both poles simultaneously to their respective tori.

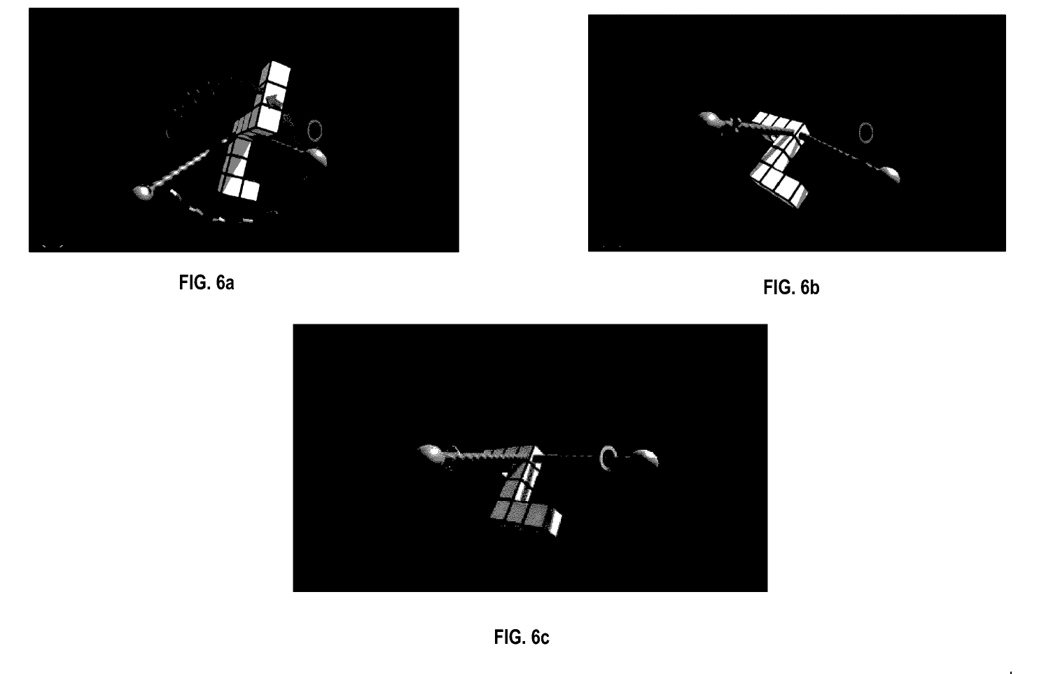

An example rotation of a physical object by a local user in accordance with the foregoing technique is depicted in FIGS. 6a to 6c. As shown in FIG. 6a, the target orientation of the depicted physical object is represented by the set of two tori. Further, two poles (handloes) extend from the point about which the virtual proxy will rotate. It is the task of the local user to align each pole with its matching torus. For the convenience of the local user, a pole and its corresponding torus are rendered on the display in the same color. As shown, extending from each pole is a set of arrows that shows the rotational path from the pole to its corresponding torus.

In FIG. 6b, one of the poles has been successfully rotated to its corresponding torus (i.e., its target position). As shown, the remaining pole is still to be rotated to its target position inside of its corresponding torus. Accordingly, the set of arrows that show the remaining rotational path from each pole to its corresponding torus is depicted as being smaller than depicted in FIG. 6a. Finally, as shown in FIG. 6c, as the local user rotates the second pole to its the target pose, the second set of arrows is updated and removed from the display, indicating that the local user has successfully manipulated the virtual proxy to its target orientation.

As the visibility of the tori is crucial for the successful completion of the rotation task, especially in the fine tuning stage, embodiments disclosed herein employ a heuristic where a vector is provided that connects the point about which the virtual proxy will be rotated to the center of projection of the virtual camera. A first copy of that vector is rotated clockwise by a predetermined amount (e.g., 30°) about the virtual camera's up-vector and the intersection of that rotated vector with a spherical hull containing the virtual proxy determines the position of the left torus. A second copy of that vector is rotated counterclockwise by a predetermined amount (e.g., 30°) about the virtual camera's up-vector and the intersection of that rotated vector with a spherical hull containing the virtual proxy determines the position of the right torus.

This can be done to ensure that the virtual proxy would never touch or occlude the tori in any orientation. This heuristic provides two locations that are projected to lie on the horizontal centerline of the screen on which the virtual proxy is displayed (or on a line parallel to the horizontal centerline). Selecting the locations to place the tori requires that the poles be attached in different orientations relative to the virtual proxy for each new target pose. The positions to which the poles are attached to the virtual proxy are calculated during initialization by applying the inverse of the rotation between the current orientation to the target orientation to the tori positions.

Further, as shown in FIGS. 6a to 6c, to provide a local user with a sense of which direction to move the physical object, arrows that connect each handle to its corresponding torus are provided. Each set of arrows can be displayed as “cookie crumb” arrows that trace the ideal path of the handles when both of handles are moved towards their targets simultaneously. As shown, the trail of arrows gets shorter as the local user rotates the object and the remaining angle of rotation decreases.

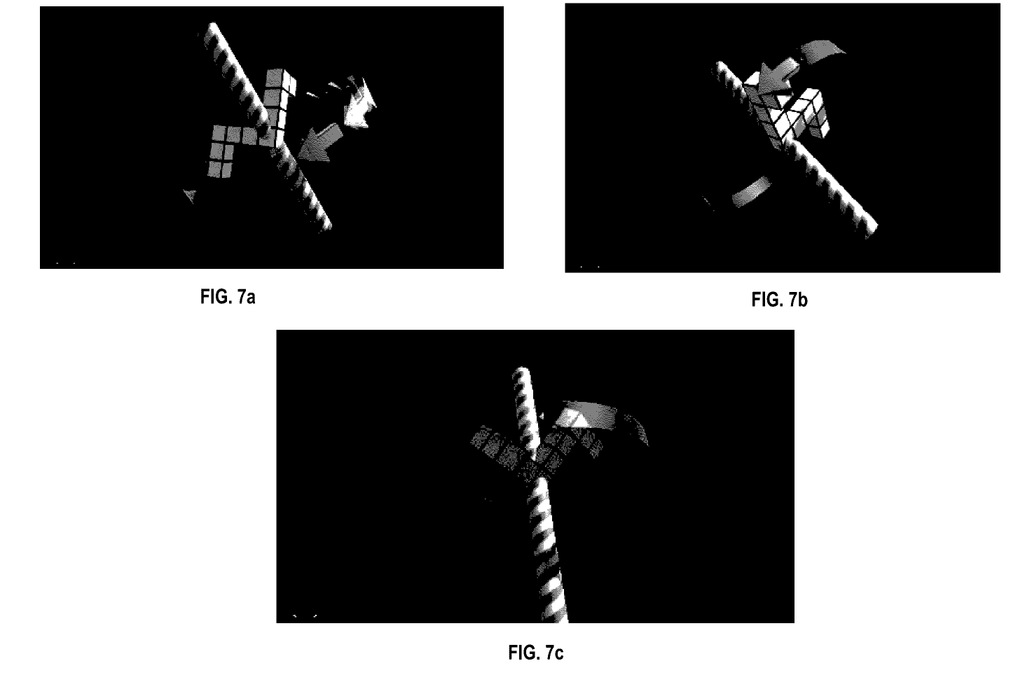

In another embodiment, another visualization technique for displaying a virtual proxy is provided. In this approach, a ring with small repeating dynamic rectangular 3D arrows is rendered around the virtual proxy, and perpendicular to the axis of optimal rotation. In addition, a cylinder is rendered on the display, which is tied to the axis of optimal rotation and pierces the center of the virtual proxy. As the local user rotates the tracked object, the axis and ring update to reflect the new axis and direction for a rotation from the tracked object's current orientation to the target orientation. As the magnitude of rotation gets smaller, the number of arrows decreases. In some embodiments, a single arrow is rendered instead of a set of smaller arrows. In this case, the single arrow will collapse from head to tail as it disappears. A sample rotation of a virtual proxy in accordance with this embodiment is depicted in FIGS. 7a to 7c.

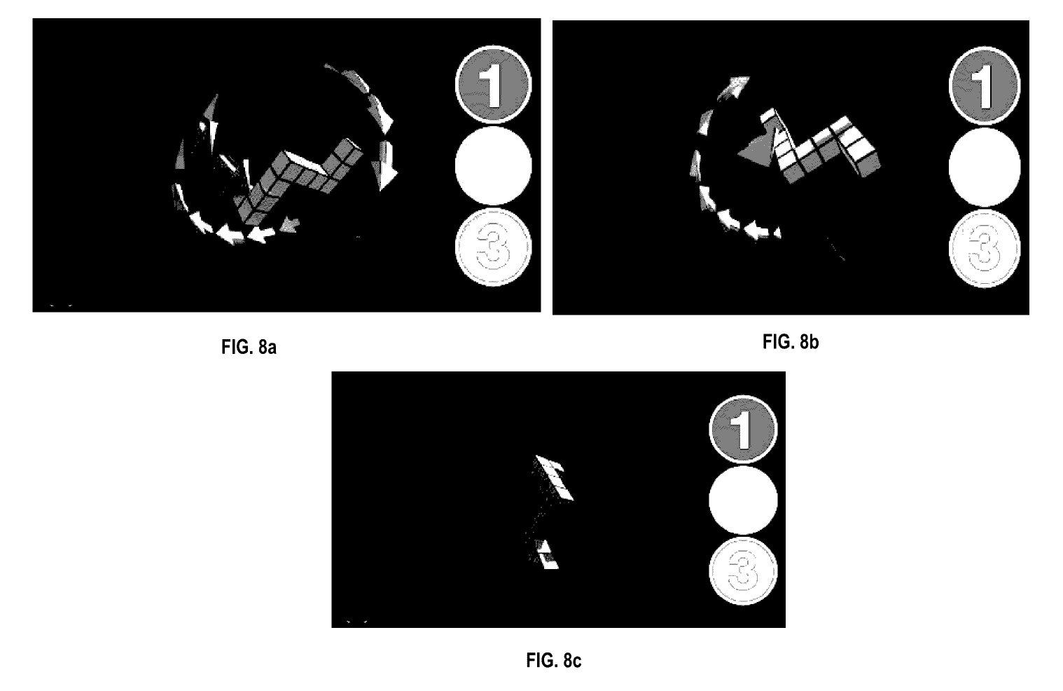

In another aspect of the current disclosure, another visualization technique is provided. In this embodiment, the axes of rotation for a virtual proxy are described by three sets of arrows, each of which is color coded to represent an intended order of rotation based on the decomposition of the quaternion representing the remaining rotation of the proxy. For each axis, each set of arrows is rendered in a ring that is perpendicular to a particular principal axis of the virtual proxy. These arrows smoothly disappear as the virtual proxy is manipulated toward its target position along the axis corresponding to the arrows. Further, the front of the rotation path is anchored at the point on the ring closest to the virtual camera. Upon nearing a completion threshold for a particular axis, the ring disappears from the display. However, the ring reappears if the local user breaks from the target orientation about that particular axis. A sample rotation of a virtual proxy in accordance with this embodiment is depicted in FIGS. 8a to 8c.

As mentioned above, there can be a defined order for the axes about which the local user should rotate the object when following the instructions. Accordingly, as shown in the figures, to aid the local user in following this preferred order of axes around which to rotate the object, three icons are rendered on the display, which indicate the order of rotation, represented by number and color.

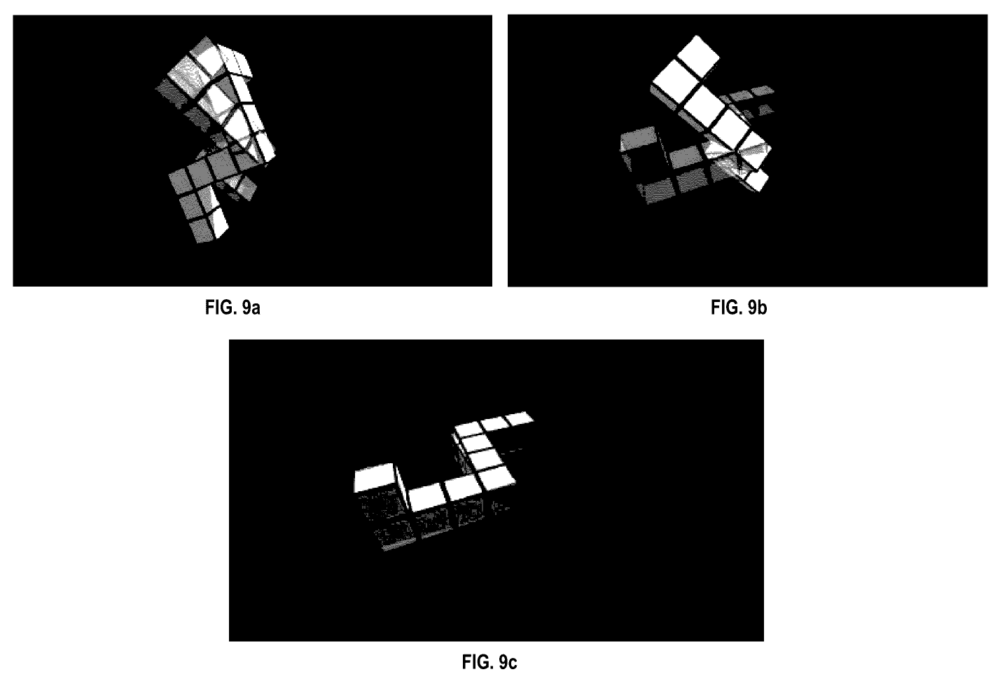

In still another embodiment of the current disclosure, a visualization technique using animation is provided. In this embodiment, the virtual proxy is animated from its tracked (i.e., current) orientation to the target orientation. To simultaneously provide feedback on both current orientation and desired motion, an animating copy of the virtual proxy is displayed. In order to address the situation where the animating copy is difficult to distinguish from the virtual proxy (which is caused by overlapping of these elements), the transparency of the animating copy is modified to 50% and its outline is changed from, for example, solid black lines to dashed grey lines. A sample rotation of a virtual proxy in accordance with this embodiment is depicted in FIGS. 9a to 9c. The faded visual style for the animating copy is also referred to as ghosting, which is an illustrative technique used, for example, in comics, where an object is rendered semitransparent to represent its past or future state.

In order to provide continuous feedback to the local user, animation is repeated once the animating copy nears the target orientation. This is accomplished by rewinding the animating copy to the tracked object's current orientation. To reduce the perception of visually jarring effects by the local user, an ease-in, ease-out interpolator is provided. Further, in some embodiments, the rotational speed of the animation is set to 90° per second. This results in the animation repeating more frequently as the tracked object nears its target orientation. However, when the frequency of repetition becomes too high, it can become difficult to distinguish between the animation progressing forward and rewinding back to the current orientation. Thus, some embodiments address this issue by introducing a predetermined time gap between animations. Further, in some embodiments the total animation duration is limited to lie within a predetermined time interval (for example, between 0.2 and 2 seconds) in order to avoid animations being too quick or too slow to be helpful to the local user.

Although one or more embodiments have been described herein in some detail for clarity of understanding, it should be recognized that certain changes and modifications can be made without departing from the spirit of the disclosure. The embodiments described herein can employ various computer-implemented operations involving data stored in computer systems. For example, these operations can require physical manipulation of physical quantities—usually, though not necessarily, these quantities can take the form of electrical or magnetic signals, where they or representations of them are capable of being stored, transferred, combined, compared, or otherwise manipulated. Further, such manipulations are often referred to in terms, such as producing, yielding, identifying, determining, or comparing. Any operations described herein that form part of one or more embodiments of the disclosure can be useful machine operations. In addition, one or more embodiments of the disclosure also relate to a device or an apparatus for performing these operations. The apparatus can be specially constructed for specific required purposes, or it can be a general-purpose computer selectively activated or configured by a computer program stored in the computer. In particular, various general-purpose machines can be used with computer programs written in accordance with the teachings herein, or it can be more convenient to construct a more specialized apparatus to perform the required operations.

The embodiments described herein can be practiced with other computer system configurations including hand-held devices, microprocessor systems, microprocessor-based or programmable consumer electronics, minicomputers, mainframe computers, and the like. Further, embodiments described herein can be implemented using head-worn displays that are head-tracked, head-worn displays that are not head-tracked, handheld displays, as well as other displays that are worn by or mounted external to an end user. Further, embodiments can be implemented using any display technology capable of rendering, or otherwise allowing the user to see, the virtual and physical objects described herein.

One or more embodiments of the present disclosure can be implemented as one or more computer programs or as one or more computer program modules embodied in one or more computer-readable media. The term computer readable medium refers to any data storage device that can store data which can thereafter be input to a computer system—computer-readable media can be based on any existing or subsequently developed technology for embodying computer programs in a manner that enables them to be read by a computer. Examples of a computer-readable medium include a hard drive, network-attached storage (NAS), read-only memory, random-access memory (e.g., a flash-memory device), a CD (Compact Disc)-ROM, a CD-R, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present disclosure have been described in some detail for clarity of understanding, it will be apparent that certain changes and modifications can be made within the scope of the claims. Accordingly, the described embodiments are to be considered as illustrative and not restrictive, and the scope of the claims is not to be limited to details given herein, but can be modified within the scope and equivalents of the claims. In the claims, elements do not imply any particular order of operation, unless explicitly stated in the claims.

Many variations, modifications, additions, and improvements can be made. Plural instances can be provided for components, operations or structures described herein as a single instance. Boundaries between various components, operations and data stores are somewhat arbitrary, and particular operations are illustrated in the context of specific illustrative configurations. Other allocations of functionality are envisioned and can fall within the scope of the disclosure(s). In general, structures and functionality presented as separate components in exemplary configurations can be implemented as a combined structure or component. Similarly, structures and functionality presented as a single component can be implemented as separate components. These and other variations, modifications, additions, and improvements can fall within the scope of the appended claim(s).

What is claimed is:

1. A method for providing task guidance, the method comprising:
tracking and viewing first and second objects on a first display;
viewing third and fourth objects on a second display, wherein the third and fourth objects correspond to the tracked first and second objects;
selecting the third object and creating a first virtual replica thereof on the second display;
selecting the fourth object and creating a second virtual replica thereof on the second display;
selecting and annotating the first and second virtual replicas;
responsive to annotating the first and second virtual replicas:
rendering corresponding annotations to the third and fourth objects on the second display; and
rendering corresponding annotations to the first and second tracked objects on the first display.

2. The method of claim 1,
wherein annotating the first virtual replica comprises creating one or more contact points, each contact point being at a location on a surface of the first virtual replica,
wherein annotating the second virtual replica comprises creating one or more contact points, each contact point being at a location on the second virtual replica, and
wherein the method further comprises:
associating each contact point on the first virtual replica with a contact point on the second virtual replica; and
generating and displaying on the second display one or more lines, wherein each line connects associated contact points.

3. The method of claim 2, further comprising
displaying one or more contact points and one or more lines on the first display,
wherein each contact point displayed on the first display corresponds to one of the contact points created on the first or second virtual replicas, each line displayed on the first display corresponds to one of the lines displayed on the second display, and wherein each contact point on the first display is displayed at a location on a tracked object that corresponds to the location at which its corresponding contact point is rendered on the object on the second display to which the tracked object corresponds.

4. The method of claim 1, wherein at least one of the first and second displays is a head-worn display (HWD).

5. The method of claim 1, wherein the first and second displays are co-located with one another.

6. The method of claim 1, wherein the first and second tracked objects are physical objects and the third and fourth objects are virtual proxies of the first and second tracked objects.

7. A method for providing task guidance, the method comprising:
tracking and rendering first and second objects on a first display;
viewing third and fourth objects on a second display, wherein the third and fourth objects correspond to the tracked first and second objects;
selecting the third object on the second display and creating a virtual replica thereof;
responsive to creating the virtual replica, viewing on the first display a corresponding virtual replica of the first tracked object;
selecting and moving the virtual replica to a position relative to the fourth object on the second display;
responsive to moving the virtual replica on the second display, moving the corresponding virtual replica on the first display to a position relative to the second tracked object, wherein said position relative to the second tracked object corresponds to the position of the virtual replica on the second display relative to the fourth object.

8. The method of claim 7, further comprising
creating one or more constraints on the movement of the virtual replica on the second display; and
applying the one or more constraints to the movement of the virtual replica when the virtual replica is moved to within a predetermined distance from the fourth object.

9. The method of claim 7, wherein at least one of the first and second displays is a head-worn displays (HWD).

10. The method of claim 7, wherein the first and second displays are co-located with one another.

11. The method of claim 7, wherein the first and second tracked objects are physical objects and the third and fourth objects are virtual proxies of the first and second tracked objects.

12. A method for providing task guidance, the method comprising:
tracking and viewing an object using a display;
determining a target orientation for the object;
viewing a pair of virtual handles using the display such that each virtual handle originates at the point about which the object will rotate, extends outward, and is rigidly attached to the object;
viewing a pair of target shapes using the display, each target shape corresponding to one of the virtual handles, wherein both virtual handles overlap with their corresponding target shapes when the object is at the target orientation.

13. The method of claim 12, further comprising:
responsive to changes in the orientation of the tracked object, making corresponding changes to the orientation of the object and the virtual handles viewed using the display;
determining whether either of the virtual handles overlaps with its corresponding target shape; and
if either of the virtual handles overlaps with its corresponding target shape, displaying a visual indication using the display.

14. The method of claim 12, wherein the display is a head-worn display (HWD).

15. The method of claim 12, wherein the tracked object is a physical object.

16. The method of claim 12, wherein the tracked object is a virtual object.

17. A system for providing task guidance, the system comprising:
a processor;
a memory; and
first and second displays,
wherein the system is configured to:
track and view first and second objects on the first display;
view third and fourth objects on the second display, wherein the third and fourth objects correspond to the tracked first and second objects;
select the third object and create a first virtual replica thereof on the second display;
select the fourth object and creating a second virtual replica thereof on the second display;
select and annotate the first and second virtual replicas;
responsive to annotating the first and second virtual replicas:
render corresponding annotations to the third and fourth objects on the second display; and
render corresponding annotations to the first and second tracked objects on the first display.

18. The system of claim 17,
wherein annotating the first virtual replica comprises creating one or more contact points, each contact point being at a location on the first virtual replica,
wherein annotating the second virtual replica comprises creating one or more contact points, each contact point being at a location on the second virtual replica, and
wherein the system is further configured to:
associate each contact point on the surface of the first virtual replica with a contact point on the second virtual replica; and
generate and display on the second display one or more lines, wherein each line connects associated contact points.

19. The system of claim 18, wherein the system is further configured to
display one or more contact points and one or more lines on the first display,
wherein each contact point displayed on the first display corresponds to one of the contact points created on the first or second virtual replicas, each line displayed on the first display corresponds to one of the plurality of lines displayed on the second display, and wherein each contact point rendered on the first display is rendered at a location on the tracked object that corresponds to the location at which the corresponding contact point is rendered on the object on the second display to which the tracked object corresponds.

20. A system for providing task guidance, the system comprising:
a processor;
a memory; and
a display,
wherein the system is configured to:
track and view an object on a display;
determine a target orientation for the object;
view a pair of virtual handles using the display such that each virtual handle originates at the point about which the object will rotate, extends outward, and is rigidly attached to the object;
view a pair of target shapes using the display, each target shape corresponding to one of the virtual handles, wherein both virtual handles overlap with their corresponding target shapes when the object is at the target orientation.

21. The system of claim 20, wherein the processor is further programmed to:
responsive to changes in the orientation of the tracked object, make corresponding changes to the orientation of the object and the virtual handles viewed using the display;
determine whether either of the virtual handles overlaps with its corresponding target shape; and
if either of the virtual handles overlaps with its corresponding target shape, display a visual indication using the display.
